(19) United States
(12) Patent Application Publication
(10) Pub. No.: US 2005/0123108 A1
(43) Pub. Date: Jun. 9, 2005

(54) Hands-free modem-on-hold

(76) Inventor: Wesley H. Smith, Raleigh, NC (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/731,267

(22) Filed: Dec. 8, 2003

(51) Int. Cl. H04M 11/00

(52) U.S. Cl. 379/93.35; 379/93.31

(57) ABSTRACT

Hands-free telephone calls with a computer system or other electronic device while a modem maintains a data session established before the telephone call are described.

### TECHNICAL FIELD

The invention relates to modems. More particularly, the invention relates to allowing a hands-free telephone call with an electronic system (e.g., a computer system) while maintaining, with a modem, a data connection established before the telephone call is received and/or placing a hands-free telephone call while maintaining a data connection established before the telephone call is placed.

### BACKGROUND

Currently, even with a rapid increase of Internet access via cable modems and digital subscriber line (DSL) connections, the most common technique for accessing the Internet is over a telephone line with a modem. When a modem is being used by a computer system or other device to communicate over a telephone line, the telephone line is not available for telephone calls, which is an inconvenience to people who my be interested in using the telephone line for telephone calls.

One shortcoming of modem use for data communication is that the telephone line used for data communication cannot be simultaneously used for voice communications. As a result a user must have a dedicated data communication line, which can be costly, or have a mechanism that allows for switching between data communications and voice communications using a single telephone line.

Devices and techniques that allow computer users to accept incoming telephone calls while a telephone line is being used by a modem currently exist. However, these devices and techniques are generally inconsistent and/or inconvenient for the user.

### BRIEF DESCRIPTION OF THE DRAWINGS

The invention is illustrated by way of example, and not by way of limitation, in the figures of the accompanying drawings in which like reference numerals refer to similar elements.

FIG. 1 is a block diagram of one embodiment of an electronic system having a modem.

FIG. 2 is a conceptual block diagram of one embodiment of components to provide hands-free telephony in an electronic system having a modem.

FIG. 3 is a flow diagram of one embodiment of a process for providing a hands-free telephone call received during a data communications session.

FIG. 4 is a flow diagram of one embodiment of a process for placing a hands-free telephone call during a data communications session.

### DETAILED DESCRIPTION

Methods and apparatuses for hands-free telephone calls with a computer system or other electronic device while a modem maintains a data session established before the telephone call are described. In the following description, for purposes of explanation, numerous specific details are set forth in order to provide a thorough understanding of the invention. It will be apparent, however, to one skilled in the art that the invention can be practiced without these specific details. In other instances, structures and devices are shown in block diagram form in order to avoid obscuring the invention.

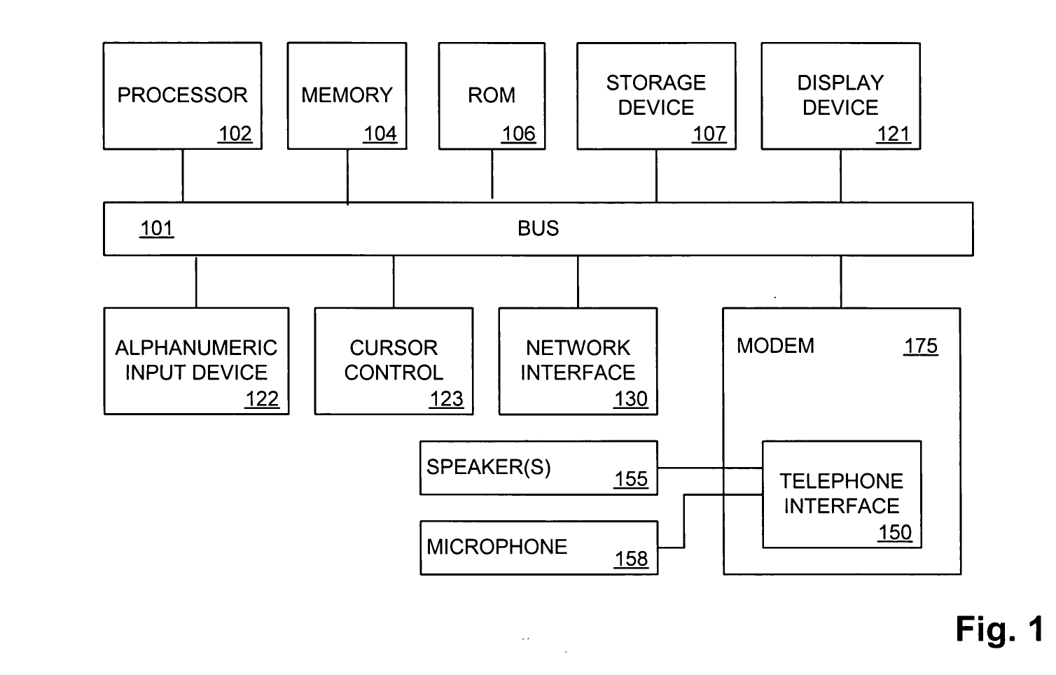

FIG. 1 is a block diagram of one embodiment of an electronic system having a modem. The electronic system illustrated in FIG. 1 is intended to represent a range of electronic systems, for example, computer systems (whether desktop, laptop, palmtop, or other), network access devices, personal digital assistants (PDAs), set-top boxes, etc. Alternative systems, whether electronic or non-electronic, can include more, fewer and/or different components. The components of FIG. 1 can also be included within another, larger system.

Electronic system 100 includes bus 101 or other communication device to communicate information, and processor 102 coupled to bus 101 to process information. While electronic system 100 is illustrated with a single processor, electronic system 100 can include multiple processors and/or co-processors. Electronic system 100 further includes random access memory (RAM) or other dynamic storage device 104 (referred to as memory), coupled to bus 101 to store information and instructions to be executed by processor 102. Memory 104 also can be used to store temporary variables or other intermediate information during execution of instructions by processor 102.

Electronic system 100 also includes read only memory (ROM) and/or other static storage device 106 coupled to bus 101 to store static information and instructions for processor 102. Data storage device 107 is coupled to bus 101 to store information and instructions. Data storage device 107 such as a magnetic disk or optical disc and corresponding drive can be coupled to electronic system 100.

Electronic system 100 can also be coupled via bus 101 to display device 121, such as a cathode ray tube (CRT) or liquid crystal display (LCD), to display information to a user. Alphanumeric input device 122, including alphanumeric and other keys, or a touch pad interface, is typically coupled to bus 101 to communicate information and command selections to processor 102. Another type of user input device, cursor control 123, such as a mouse, a trackball, or cursor direction keys to communicate direction information and command selections to processor 102 and to control cursor movement on display 121. Electronic system 100 further includes network interface 130 to provide access to a network, such as a local area network.

Electronic system 100 further includes speaker(s) 155 and microphone 158 coupled with telephone interface 150. Telephone interface 150 is coupled with bus 101 and is configured to allow a user of electronic system 100 to place and receive telephone calls using electronic system 100. In one embodiment speaker(s) 155 and microphone 158 are integrated within a casing of electronic system 100, or otherwise disposed so that the user of electronic system 100 can engage in a telephone conversation without holding a headset. That is, the user of electronic system 100 is not required to us his/her hands to engage in a telephone conversation. Receiving or initiating a telephone call may or may not require the user of electronic system 100 to use his/her hands.

Electronic system 100 further includes modem 175 coupled with bus 101. Modem 175 allows electronic system 100 to communicate digital data over an analog communications medium, such as, for example, a telephone line. The general technique for communicating digital data over an analog communications medium is known in the art. As described in greater detail below, modem 175 is capable of maintaining a data connection for at least a predetermined period of time while a telephone call is transmitted or received via telephone interface 150. In one embodiment, telephone interface 150, speaker(s) 155 and/or microphone 158 are part of modem 175. In alternate embodiments, some or none of telephone interface 150, speaker(s) 155 and/or microphone 158 are part of modem 175.

In one embodiment, telephone interface 150 and modem 175 operate in response to call waiting services provided by a telephone company. Telephone interface 150 and modem 175 accept an incoming telephone call without releasing the data connection. When the telephone call is terminated the modem 175 reconnects or continues where the data connection was interrupted.

As described in greater detail below, modem 175 places the data session “on hold” for a period of time (e.g., 4 minutes, 15 minutes, undetermined). The telephone call, whether incoming or outgoing, is processed by electronic system 100 so that a user can engage in a “hands-free” telephone conversation. When the telephone call is terminated, the data session is resumed. Thus, for an incoming call, a user of electronic system 100 can be engaged in a data session (e.g., using a telephone line to access the Internet) and be notified of an incoming telephone call. The user can accept the incoming telephone call, which places the data session on hold and uses at least one speaker and microphone of electronic system 100 to participate in the telephone call. Similarly, for an outgoing telephone call, the data session is placed on hold and at least one speaker and microphone of electronic system 100 to participate in the telephone call.

Instructions are provided to memory from a storage device, such as magnetic disk, a read-only memory (ROM) integrated circuit, CD-ROM, DVD, via a remote connection (e.g., over a network via network interface 130) that is either wired or wireless providing access to one or more electronically-accessible media, etc. In alternative embodiments, hard-wired circuitry can be used in place of or in combination with software instructions. Thus, execution of sequences of instructions is not limited to any specific combination of hardware circuitry and software instructions.

An electronically-accessible medium includes any mechanism that provides (i.e., stores and/or transmits) content (e.g., computer executable instructions) in a form readable by an electronic device (e.g., a computer, a personal digital assistant, a cellular telephone). For example, a machine-accessible medium includes read only memory (ROM); random access memory (RAM); magnetic disk storage media; optical storage media; flash memory devices; electrical, optical, acoustical or other form of propagated signals (e.g., carrier waves, infrared signals, digital signals); etc.

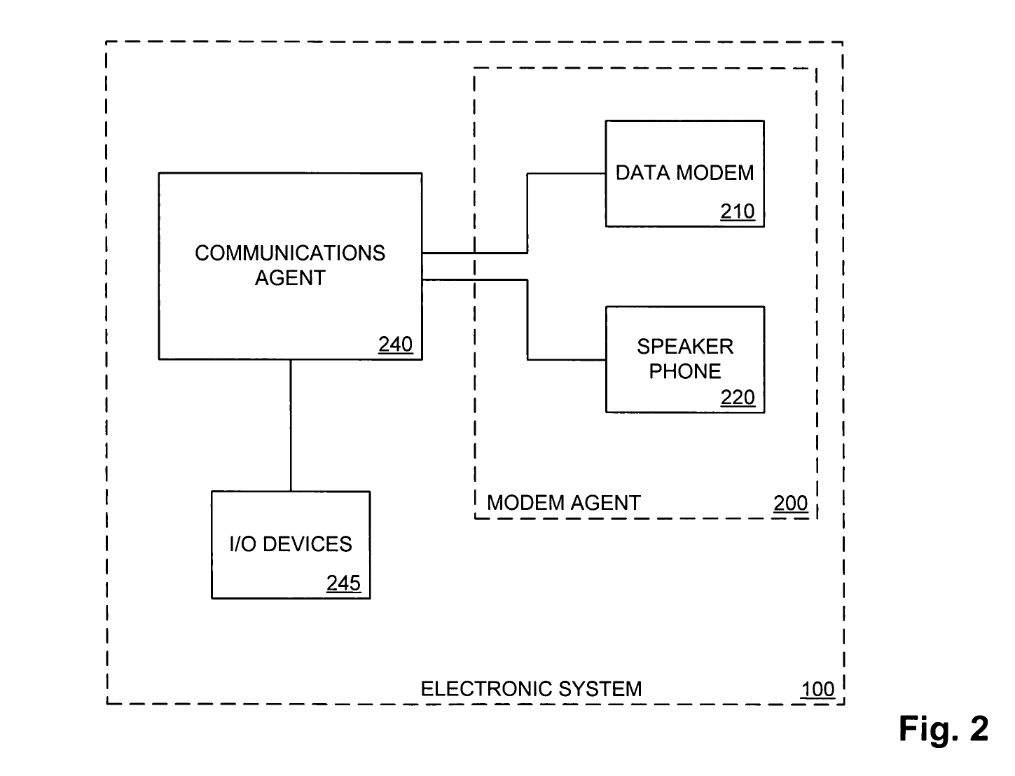

FIG. 2 is a conceptual block diagram of one embodiment of components to provide hands-free telephony in an electronic system having a modem. The components illustrated in FIG. 2 can be implemented as hardware, software or any combination of hardware and software. Further, the components of FIG. 2 can be within the one or more blocks of electronic system 100 of FIG. 1.

Communications agent 240 provides data and/or control signals to data modem 210 and to speaker phone 220. In one embodiment, data modem 210 and speaker phone 220 are included in modem agent 200. In alternate embodiments, data modem 210 and speaker phone 220 can be separate components. Both data modem 210 and speaker phone 220 are coupled to access the same telephone line. Speaker phone 220 includes at least one speaker and at least one microphone (not illustrated in FIG. 2) that allow a user of electronic system 100 to engage in a telephone conversation without being required to hold a handset or to wear a headset.

Data modem 210 and speaker phone 220 interact with communications agent 240 to provide hands-free telephony during a data session by placing the data session on hold to process a telephone call. As discussed above, electronic system 100 includes one or more I/O devices (labeled 245) that allow a user to interact with communications agent 240.

In one embodiment, data modem 210 and communications agent 240 are implemented as a modem device to be used in a computer system, for example, a Peripheral Component Interconnect (PCI) based modem card to be placed in a PCI-compliant slot in the computer system and coupled with a PCI-compliant bus of the computer system. One embodiment of a PCI protocol and bus is described in PCI Specification Revision 2.1 developed by the PCI Special Interest Group of Portland, Oregon. Other interfaces and protocols can also be used, for example, PCI-Express Interface developed by Intel Corporation of Santa Clara, Calif.

In one embodiment, external speakers and/or microphone(s) are used for the hands-free telephone call. Some electronic systems have integrated speakers and/or microphone(s). If integrated speakers and/or microphone(s) are available use of external components may not be necssary.

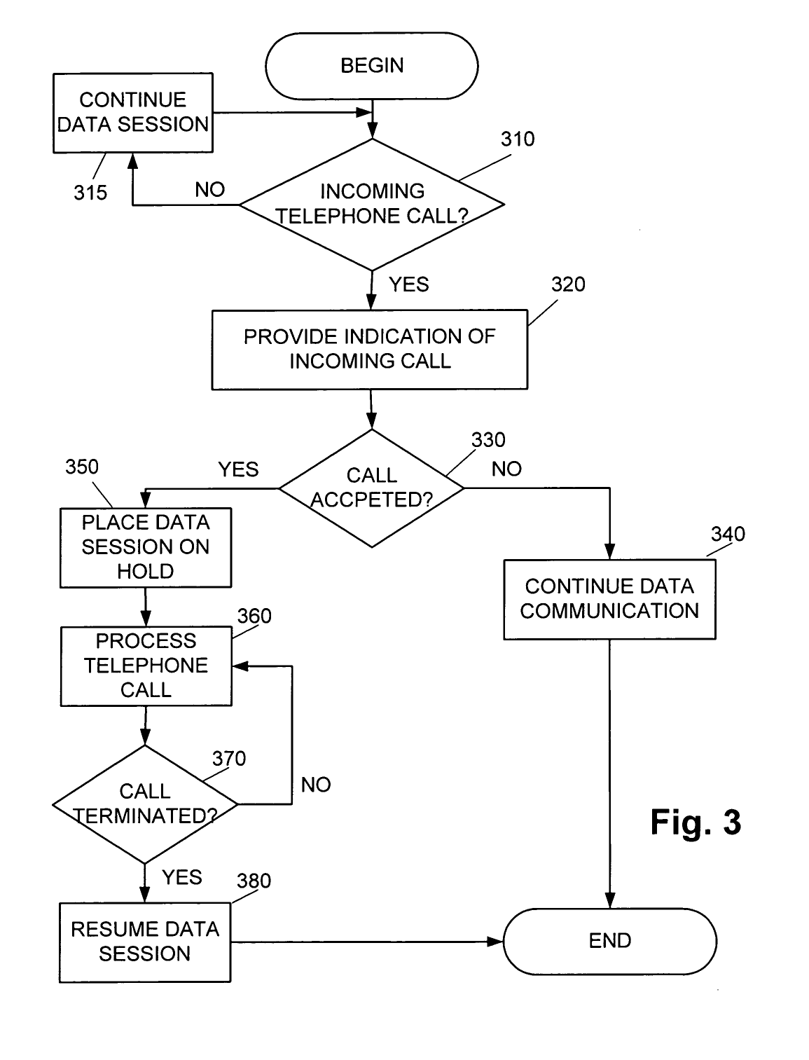

FIG. 3 is a flow diagram of one embodiment of a process for providing a hands-free telephone call received during a data communications session. The process of FIG. 3 is performed after the initiation of a data session. In other words, a modem of an electronic system is used to establish a data session prior to receipt of the incoming telephone call. The modem used to establish the data session can communicate over either a wired or a wireless communications medium.

A telephone interface of the electronic system determines whether a telephone call is incoming, 310. If the telephone interface detects no incoming call, the modem continues the data session 315. If an incoming telephone call is detected at 310, the electronic system provides an indication of the incoming call, 320. In one embodiment, the modem of the electronic system detects the incoming call by detecting a call waiting signal. In one embodiment, the call waiting signal includes an indication of the source of the telephone call (e.g., a caller ID identifier). The indication of the incoming call can be provided, for example, with a pop-up window or an audible tone.

In one embodiment, the complete telephone call transaction can be completed in a hands-free manner. For example, the electronic system can provide a prompt indicating an incoming telephone call. The prompt can be a visual prompt (e.g., a pop-up window), an audio prompt (e.g., a beep or other tone), or a combination of visual and audio prompts. In one embodiment, the prompt is a recorded or simulated human voice indicating the incoming telephone call. The prompt can indicate the source of the telephone call as well as the option to accept the telephone call.

The user of the electronic system can respond to the prompt in any appropriate manner. For example, the user can click on a button of a dialog box or press a button. In one embodiment, the user responds to the prompt with a voice command. The user can either accept or reject the incoming telephone call with a voice command.

If the telephone call is not accepted at 330, the data session is continued, 340. The call can be accepted by a user of the electronic system by, for example, clicking a button, pressing a key, or providing an audible (e.g., vocal) response. If the telephone call is accepted at 330, the data session is placed on hold, 350. Placing the data session on hold is described in greater detail below. In one embodiment, the process of placing the data session on hold is performed by the modem.

When the data session has been placed on hold, the telephone call is processed, 360. In one embodiment, processing the telephone call involves receiving the analog signals from the telephone connection and playing the signals using one or more speakers of the electronic system. Digital voice signals can also be played. Voice signals from one or more microphones of the electronic system are transmitted over the telephone connection.

Processing of the telephone call continues until the telephone call is terminated, 370. In one embodiment, the telephone call is terminated in response to a voice command from the user. In alternate embodiments, the call can be terminated by the user pressing a button or selecting a command or graphical button. When the telephone call is terminated at 370, the data session is resumed, 380.

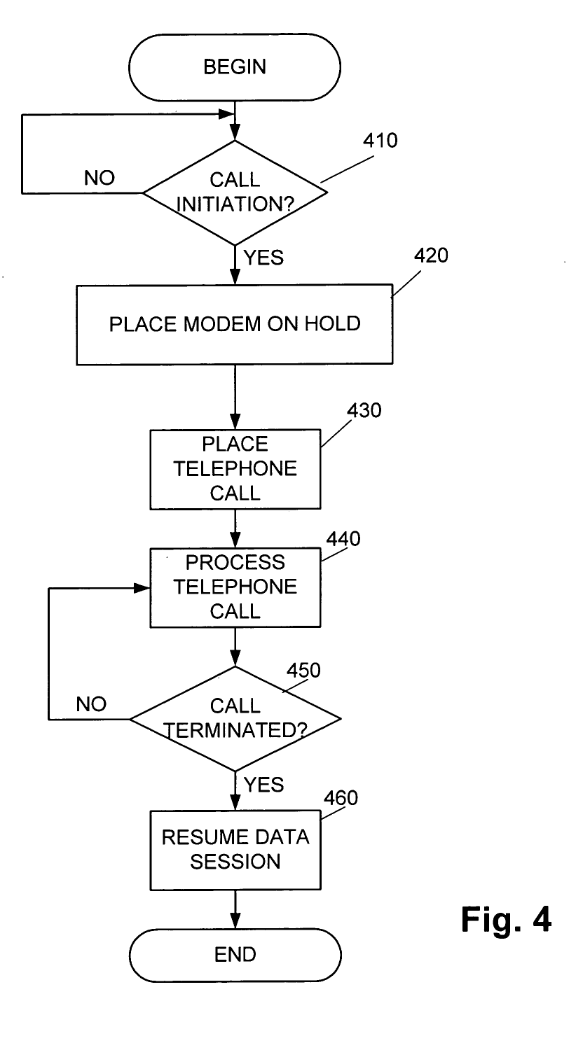

FIG. 4 is a flow diagram of one embodiment of a process for placing a hands-free telephone call during a data communications session. The process of FIG. 4 is performed after the initiation of a data session.

The data session continues until a call is initiated at 410. In one embodiment, the call is initiated in response to a voice command by a user of an electronic system. In alternate embodiments, the call can be initiated, for example, by the user pressing a button, or selecting a command using a graphical user interface.

When a telephone call is initiated at 410, the modem is placed on hold, 420. The data session is then suspended while the telephone call is placed, 430. For example, a user can provide a voice command to initiate a telephone call. The user can then be prompted for the telephone number for the call, which can be used to place the call. The telephone call is processed, 440 until the call is terminated, 450. In response to the call being terminated, the data session is resumed, 460.

In one embodiment, the telephone call is terminated in response to a voice command from the user. In alternate embodiments, the call can be terminated by the user pressing a button or selecting a command or graphical button. As discussed above, when a telephone call is initiated or accepted, the modem used for data communications places the data session on hold. In one embodiment, the modem conforms to ITU-T standard V.92 (SERIES V: DATA COMMUNICATION OVER THE TELEPHONE NETWORK, Simultaneous transmission of data and other signals), published November, 2000. In alternate embodiments, other modem standards and/or protocols can be used, for example, future developments and/or wireless protocols.

If the modem is a V.92 (or subsequent standard) modem, the modem-on-hold feature defined by the standard to place the data session on hold. Other techniques can also be used to place the data session on hold. According to the V.92 standard implementation, the remote modem must also be a V.92 standard modem and the modem-on hold feature must be enabled. Details of the modem on hold feature can be found in the V.92 standard cited above.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

In the foregoing specification, the invention has been described with reference to specific embodiments thereof. It will, however, be evident that various modifications and changes can be made thereto without departing from the broader spirit and scope of the invention. The specification and drawings are, accordingly, to be regarded in an illustrative rather than a restrictive sense.

1. A method comprising:
transmitting data from an electronic system over a communications medium, the data transmission associated with a data session;
receiving an indication of an incoming telephone call transmitted over the communications medium; and
maintaining the data session while halting the data transmission and handling the incoming telephone call using a microphone and a speaker of the electronic system.

2. The method of claim 1 wherein the handling the incoming telephone call using a microphone and a speaker of the electronic system is performed in response to a voice command.

3. The method of claim 1 wherein maintaining the data session while halting the data transmission and handling the incoming telephone call comprises:
maintaining the data session using the modem-on-hold feature of the V.92 protocol;
playing voice signals from the incoming telephone call using the speaker of the electronic system;
receiving audio input via the microphone of the electronic system; and
transmitting data representing the audio input over the communications medium.

4. The method of claim 1 further comprising resuming transmission of data over the communications medium upon termination of the incoming telephone call.

5. The method of claim 4 wherein termination of the incoming telephone call occurs in response to a voice command.

6. The method of claim 1 further comprising:
receiving an indication of a source of the incoming telephone call; and
providing an output, via the electronic device, indicating the source of the incoming telephone call.

7. The method of claim 6 wherein the indication of the source comprises a caller ID signal.

8. An apparatus comprising:
a modem to transmit and receive data via a communications medium during a data session during which the modem transmits data to and receives data from a remote device, wherein the modem detects an indication of an incoming telephone call and maintains the data session while halting transmission and receipt of data in response to the indication of the incoming telephone call; and
a telephone call handling circuit coupled with the communications medium to cause audio signals from the incoming telephone call to be played by a speaker coupled with the telephone call handling circuit, to receive audio signals via a microphone coupled with the telephone call handling circuit and to transmit the audio signals over the communications medium.

9. The apparatus of claim 8 wherein the incoming telephone call is accepted in response to a voice command.

10. The apparatus of claim 8 wherein the modem resumes transmitting and receiving data in response to termination of the incoming telephone call.

11. The apparatus of claim 10 wherein the incoming telephone call is terminated in response to a voice command.

12. An article comprising a computer-readable medium having stored thereon instructions that, when executed, cause one or more processors to:
transmit data from an electronic system over a communications medium, the data transmission associated with a data session;
receive an indication of an incoming telephone call transmitted over the communications medium; and
maintain the data session while halting the data transmission and handling the incoming telephone call using a microphone and a speaker of the electronic system.

13. The article of claim 12 wherein the handling the incoming telephone call using a microphone and a speaker of the electronic system is performed in response to a voice command.

14. The article of claim 12 wherein the instructions that cause the one or more processors to maintain the data session while halting the data transmission and handling the incoming telephone call comprise instructions that, when executed, cause the one or more processors to:
maintain the data session using the modem-on-hold feature of the V.92 protocol;
play voice signals from the incoming telephone call using the speaker of the electronic system;
receive audio input via the microphone of the electronic system; and
transmit data representing the audio input over the communications medium.

15. The article of claim 12 further comprising instructions that, when executed, cause the one or more processors to resume transmission of data over the communications medium upon termination of the incoming telephone call.

16. The article of claim 15 wherein the incoming telephone call is terminated in response to a voice command.

17. A system comprising:
a twisted-pair telephone line;
a modem coupled with the twisted-pair telephone line to transmit and receive data via a communications medium during a data session during which the modem transmits data to and receives data from a remote device, wherein the modem detects an indication of an incoming telephone call and maintains the data session while halting transmission and receipt of data in response to the indication of the incoming telephone call; and
a telephone call handling circuit coupled with the communications medium to cause audio signals from the incoming telephone call to be played by a speaker coupled with the telephone call handling circuit, to receive audio signals via a microphone coupled with the telephone call handling circuit and to transmit the audio signals over the communications medium.

18. The system of claim 17 wherein the incoming telephone call is accepted in response to a voice command.

19. The system of claim 17 wherein the modem resumes transmitting and receiving data in response to termination of the incoming telephone call.

20. The system of claim 19 wherein the incoming telephone call is terminated in response to a voice command.

21. A method comprising:
transmitting data from an electronic system over a communications medium, the data transmission associated with a data session;
maintaining the data session while halting the data transmission and to initiate a telephone call; and
processing the telephone call using a microphone and a speaker of the electronic system.

22. The method of claim 21 wherein the telephone call is initiated in response to a voice command.

23. The method of claim 21 further comprising resuming transmission of data in response to termination of the telephone call.

24. The method of claim 23 further comprising terminating the telephone call in response to a voice command.

25. An article comprising a computer-readable medium having stored thereon instructions that, when executed, cause on or more processors to:
transmit data from an electronic system over a communications medium, the data transmission associated with a data session;
maintain the data session while halting the data transmission and to initiate a telephone call; and
process the telephone call using a microphone and a speaker of the electronic system.

26. The article of claim 25 wherein the telephone call is initiated in response to a voice command.

27. The article of claim 25 further comprising instructions that, when executed, cause the one or more processors to resume transmission of data in response to termination of the telephone call.

28. The article of claim 27 further comprising instructions that, when executed, cause the one or more processors to terminate the telephone call in response to a voice command.
